(19) United States
(12) Patent Application Publication
(10) Pub. No.: US 2014/0009903 A1
(43) Pub. Date: Jan. 9, 2014

(54) BACKLIGHT MODULE AND KEYBOARD USING THE SAME

(71) Applicant: Jung-Yu Peng, New Taipei City (TW)

(72) Inventor: Jung-Yu Peng, New Taipei City (TW)

(73) Assignee: JENSIN INTL TECHNOLOGY CORP., New Taipei City (TW)

(21) Appl. No.: 13/609,263

(22) Filed: Sep. 11, 2012

(30) Foreign Application Priority Data
Jul. 4, 2012 (TW) 101124053

(51) Int. Cl. F21V 8/00

(52) U.S. Cl. 362/23.03; 362/609

(57) ABSTRACT

A backlight module and a keyboard using the same are provided. The keyboard includes a keycap layer and a backlight module. The keycap layer has a plurality of key structures. The backlight module includes a light guide layer and a reflective layer. The light guide layer having a light-incident side is disposed under the keycap layer, wherein the light-incident side has a plurality of openings. The reflective layer is disposed under the light guide layer. The reflective layer has a reflective surface, a plurality of wires and a plurality of light sources. The wires and the light sources are located on the reflective surface, and the light sources respectively pass through the openings and are located at the light-incident side.

### CROSS-REFERENCE TO RELATED APPLICATION

This application claims the priority benefit of Taiwan application serial no. 101124053, filed on Jul. 4, 2012. The entirety of the above-mentioned patent application is hereby incorporated by reference herein and made a part of this specification.

### BACKGROUND OF THE INVENTION

1. Field of the Invention

The invention relates to a backlight module and a keyboard, and particularly relates to a backlight module and a keyboard using the backlight module.

2. Description of Related Art

In recent years, manufacturers have been launching various kinds of new electronic devices, which are lighter, have many different shapes, and provide more functions. Manufacturers devote themselves to develop new products in order to draw the consumers' attention and induce them to purchase the products. The keyboards of laptop or desktop computers in the early stage do not provide the function of light emitting. However, as the technology of backlight module advances, some manufacturers start equipping keyboards with backlight modules, so that keyboards can also provide the functions of illumination and ornament.

In the conventional keyboard that provides light emitting visual effect, a flexible circuit board is usually used to carry the chip for the backlight module, and the chip is for example a light emitting device package or a driving chip, wherein the light emitting device package is disposed on the flexible circuit board to form a light bar structure, and the light bar structure is adhered to a reflective sheet for reflecting a portion of the light emitted by the light source, so as to improve the efficiency of light utilization. However, the fabrication of the flexible circuit board requires very high material costs, which raises the costs of the flexible circuit board and consequently increases the production costs of the backlight module.

### SUMMARY OF THE INVENTION

The invention provides a backlight module that requires lower production costs.

The invention provides a keyboard including a backlight module that requires lower production costs.

The invention provides a backlight module, which includes a light guide layer and a reflective layer. The light guide layer has a light-incident side, and the light-incident side includes a plurality of openings. The reflective layer is disposed under the light guide layer. The reflective layer has a reflective surface, a plurality of wires, and a plurality of light sources. The wires and the light sources are configured on the reflective surface, and the light sources respectively pass through the openings and are located at the light-incident side.

The invention provides a keyboard, which includes a keycap layer and a backlight module. The keycap layer includes a plurality of key structures. The backlight module includes a light guide layer and a reflective layer. The light guide layer has a light-incident side and is disposed under the keycap layer, wherein the light-incident side has a plurality of openings. The reflective layer is disposed under the light guide layer. The reflective layer has a reflective surface, a plurality of wires, and a plurality of light sources. The wires and the light sources are configured on the reflective surface, and the light sources respectively pass through the openings and are located at the light-incident side.

In an embodiment of the invention, the wires are configured on the reflective surface of the reflective layer by printing.

In an embodiment of the invention, the reflective surface is a surface of the reflective layer, which faces the light guide layer.

In an embodiment of the invention, the light source includes a light emitting diode (LED).

In an embodiment of the invention, the light guide layer further includes a light emitting surface, and the light-incident side spans the light emitting surface.

In an embodiment of the invention, the keyboard further includes a light shielding layer disposed between the keycap layer and the backlight module and having a plurality of light emitting openings.

Based on the above, the invention directly forms wires on the reflective surface of the reflective layer by printing, etc., and configures the light sources on the reflective surface of the reflective layer to be electrically connected with the wires. Accordingly, the complex fabrication processes of forming wire layers on the flexible circuit board, soldering light sources, and adhering the flexible circuit board to the reflective layer can be spared to save the costs for fabricating the flexible circuit board. Therefore, the invention not only simplifies the fabrication processes of the backlight module but also reduces the production costs of the backlight module.

In order to make the aforementioned features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 is a schematic exploded view of a keyboard according to an embodiment of the invention.

FIG. 2 is a schematic cross-sectional view illustrating a part of a backlight module according to an embodiment of the invention.

### DESCRIPTION OF EMBODIMENTS

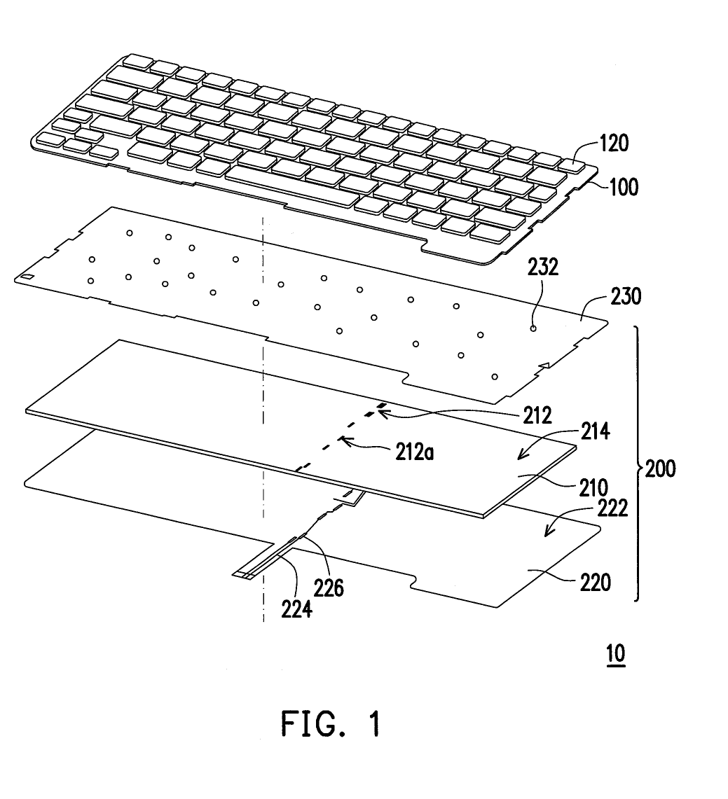

FIG. 1 is a schematic exploded view of a keyboard according to an embodiment of the invention. In this embodiment, a keyboard 10 includes a keycap layer 100 and a backlight module 200. The keycap layer 100 includes a plurality of key structures 120. The backlight module 200 includes a light guide layer 210 and a reflective layer 220. The light guide layer 210 is disposed under the keycap layer 100 and has a light-incident side 212. The light-incident side 212 has a plurality of openings 212a. The reflective layer 220 is disposed under the light guide layer 210. The reflective layer 220 includes a reflective surface 222, a plurality of wires 224, and a plurality of light sources 226.

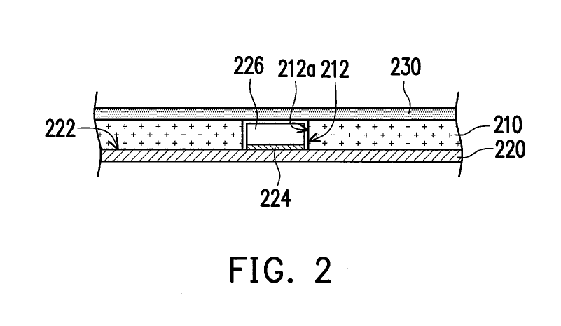

FIG. 2 is a schematic cross-sectional view illustrating a part of a backlight module according to an embodiment of the invention. Referring to FIG. 1 and FIG. 2 at the same time, the wires 224 and the light sources 226 are configured on the reflective surface 222, and the light sources 226 respectively pass through the openings 212a and are located at the light-incident side 212, wherein the reflective surface 222 is a surface of the reflective layer 220, which faces the light guide layer 210. In this embodiment, the wires 224 are formed on the reflective surface 222 of the reflective layer 220 by printing. A material of the wires 224 is a conductive silver paste, for example. The light sources 226 include light emitting diodes (LEDs), which include red light LEDs, green light LEDs, or blue light LEDs, or a combination of at least two of red light LEDs, green light LEDs, or blue light LEDs, so as to form a white light source by light mixture. The light sources 226 are directly configured on the reflective surface 222 of the reflective layer 220 and electrically connected with the wires 224 by soldering, for example. The wires 224 may be further connected to an external circuit board for controlling the brightness of the light sources 226. The reflective layer 220 reflects light back to the light guide layer 210, so as to improve the utilization efficiency of the light sources.

Based on the above configuration, there is no need to dispose the light sources 226 on a flexible substrate (e.g. flexible circuit board) with a wire layer, adhere the flexible substrate to an opposite surface of the reflective surface 222, or form openings corresponding to the light sources 226 in the reflective layer 220 for the light sources 226 to pass through. Therefore, this embodiment not only spares the costs of the flexible substrate but also simplifies the assembly process of the backlight module.

More specifically, the light guide layer 210 is composed of a transparent substrate and a light guide material disposed on the transparent substrate, for example. When the light generated by the light sources 226 enters the transparent substrate via the light-incident side 212 of the light guide layer 210, the light is reflected in the transparent substrate, and a portion of the light enters the light guide material. When the light enters the light guide material, phenomena, such as reflection, scattering, and absorption, occur, and the light reenters the light guide layer 210 and exits via a light emitting surface 214 of the light guide layer 210. The backlight module 200 of this embodiment is a side-type backlight module, and the light-incident side 212 spans the light emitting surface 214. However, it is noted that the invention does not limit the types of the backlight modules.

In this embodiment, the backlight module 200 further includes a light shielding layer 230 configured above the light guide layer 210 and having a plurality of light emitting openings 232, so that the light that exits the light emitting surface 214 of the light guide layer 210 can be emitted through the light emitting openings 232 to illuminate specific areas. In this embodiment, the light shielding layer 230 is configured between the light guide layer and the keycap layer 100. The light emitting openings 232 are, for example, formed on the light shielding layer 230 by printing or punching. In other words, a light shielding pattern having a plurality of the light emitting openings 232 is formed on the light shielding layer 230, so that the light that exits the light guide layer 210 can be emitted through a portion of the light shielding layer 230 not covered by the light shielding pattern (i.e. the light emitting openings 232) to illuminate the specific areas of the keycap layer 100.

In this embodiment, the backlight module 200 further includes an optical film (not shown). The optical film is disposed above the light guide layer 210. The optical film includes at least one of a diffuser film, a brightness enhanced film (BEF), and a prism sheet, or a combination of the above. To be more specific, the diffuser film scatters the light of the light sources 226 more uniformly, and the brightness enhanced film enhances the brightness presented by the backlight module 200. The prism sheet improves the accuracy of light emitting direction.

In conclusion of the above, the invention directly forms wires on the reflective surface of the reflective layer by printing, etc., and configures the light sources on the reflective surface of the reflective layer to be electrically connected with the wires. Accordingly, the complex fabrication processes of forming wire layers on the flexible circuit board, soldering light sources, and adhering the flexible circuit board to the reflective layer can be spared to save the costs for fabricating the flexible circuit board. Therefore, the invention not only simplifies the fabrication processes of the backlight module but also reduces the production costs of the backlight module.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A backlight module, comprising:
a light guide layer comprising a light-incident side having a plurality of openings; and
a reflective layer disposed under the light guide layer and comprising a reflective surface, a plurality of wires, and a plurality of light sources, wherein the wires and the light sources are configured on the reflective surface, and the light sources respectively pass through the openings and are located at the light-incident side.

2. The backlight module according to claim 1, wherein the wires are configured on the reflective surface of the reflective layer by printing.

3. The backlight module according to claim 1, wherein the reflective surface is a surface of the reflective layer, which faces the light guide layer.

4. The backlight module according to claim 1, wherein the light sources comprise light emitting diodes

5. The backlight module according to claim 1, wherein the light guide layer further comprises a light emitting surface, and the light-incident side spans the light emitting surface.

6. The backlight module according to claim 1, further comprising a light shielding layer configured above the light guide layer and having a plurality of light emitting openings.

7. The backlight module according to claim 1, further comprising an optical film configured above the light guide layer, wherein the optical film comprises at least one of a diffuser film, a brightness enhanced film (BEF), and a prism sheet, or a combination of the above.

8. A keyboard, comprising:
a keycap layer comprising a plurality of key structures; and
a backlight module disposed under the keycap layer and comprising:
a light guide layer comprising a light-incident side having a plurality of openings; and
a reflective layer disposed under the light guide layer and comprising a reflective surface, a plurality of wires, and a plurality of light sources, wherein the wires and the light sources are configured on the reflective surface, and the light sources respectively pass through the openings and are located at the light-incident side.

9. The keyboard according to claim 8, wherein the wires are configured on the reflective surface of the reflective layer by printing.

10. The keyboard according to claim 8, wherein the reflective surface is a surface of the reflective layer, which faces the light guide layer.

11. The keyboard according to claim 8, wherein the light sources comprise light emitting diodes

12. The keyboard according to claim 8, wherein the light guide layer further comprises a light emitting surface, and the light-incident side spans the light emitting surface.

13. The keyboard according to claim 8, wherein the backlight module further comprises a light shielding layer configured above the light guide layer and having a plurality of light emitting openings.

14. The keyboard according to claim 8, wherein the backlight module further comprises an optical film configured above the light guide layer, and the optical film comprises at least one of a diffuser film, a brightness enhanced film (BEF), and a prism sheet, or a combination of the above.
